(19) United States
(12) Patent Application Publication
(10) Pub. No.: US 2013/0241761 A1
(43) Pub. Date: Sep. 19, 2013

(54) BEAM STEERING FOR LASER RADAR AND OTHER USES

(71) Applicant: NIKON CORPORATION, Chiyoda-ku (JP)

(72) Inventors: Alexander Cooper, Belmont, CA (US); Daniel G. Smith, Tucson, AZ (US); W. Thomas Novak, Foster City, CA (US)

(73) Assignee: Nikon Corporation, Chiyoda-ku (JP)

(21) Appl. No.: 13/840,093

(22) Filed: Mar. 15, 2013

Related U.S. Application Data
(60) Provisional application No. 61/659,795, filed on Jun. 14, 2012.
(60) Provisional application No. 61/612,022, filed on Mar. 16, 2012.

(51) Int. Cl. G02B 26/10; G06F 17/50; G01S 13/86

(52) U.S. Cl. CPC G02B 26/10; G01S 13/865; G06F 17/50
USPC 342/54; 359/197.1; 359/212.1; 700/97

(57) ABSTRACT

Optical systems suitable for use as or in laser radar systems and other uses include a beam-forming unit, a beam-scan unit, and a controller. The beam-forming unit includes a first optical element, and the beam-scan unit includes a second optical element. The first optical element is movable to shape and direct a substantially collimated optical beam along a nominal propagation axis to a target, and the second optical element includes at least one movable beam deflector that moves the optical beam in a scanning manner relative to the nominal propagation axis. The controller is coupled to the beam-forming unit and beam-scan unit, and is configured to induce movement of the first optical element required for shaping and directing the optical beam along the nominal propagation axis and to induce independent motion of the beam deflector of the second optical element as required to scan the optical beam relative to the nominal propagation axis. The beam deflector can be refractive or reflective.

### CROSS-REFERENCE TO RELATED APPLICATIONS

This application claims priority to and the benefit of U.S. Provisional Application 61/659,795, filed Jun. 14, 2012, and U.S. Provisional Application No. 61/612,022, filed Mar. 16, 2012, both of which are incorporated herein by reference in their respective entireties. This application is also related to U.S. patent application Ser. No. ______, entitled “Light-Beam Scanning for Laser Radar and Other Uses,” filed concurrently with the present application and incorporated herein by reference.

### FIELD

This disclosure pertains to, inter alia, imparting a scanning or sweeping motion to a beam of light, for example a laser beam. The devices and methods disclosed herein can be used, for example, to impart a scanning or sweeping motion to an interrogation beam produced by a laser radar system.

### BACKGROUND

Various applications have been developed for using substantially collimated beams of light that are directed onto the surface of a object. One application, called laser radar, involves directing a laser beam to an object or site called a “target” herein. Laser radar (also called “LIDAR” or “LADAR”) is a remote-sensing technique used for measuring distance to and/or surface properties of a target by illuminating the target surface with light pulses produced by a laser. Laser radar systems are particularly useful for inspection applications in which large objects or complex surfaces are to be measured such as in the manufacture and assessment of aircraft, automobile, wind turbine, satellite, marine, and other oversized parts. Some conventional laser radar systems are described in the following U.S. Pat. Nos. 4,733,609; 4,824,251; 4,830,486; 4,969,736; 5,114,226; 7,139,446; and 7,925,134; and in Japan Patent No. 2,664,399, all of which are incorporated herein by reference to the fullest extent allowed by law. In these conventional laser radar systems, a laser beam (called an “interrogation beam”) is directed to and scanned over a region of the target surface. Portions of the interrogation beam that are reflected or scattered back from the target to the laser radar system are detected, and the resulting signals are processed to produce usable information about the target.

Referring to FIG. 18, a conventional laser radar system 250 typically comprises the following subsystems: (a) a source 252 of a light beam 253 (e.g., laser beam), (b) a beam-shaping optical system 254 that receives the beam 253 from the source and directs, shapes, and focuses the beam into an interrogation beam 255, (c) a sending optical system 256 that directs the interrogation beam 255 to a target 258, (d) a scanning device 260 that imparts motion to the beam-shaping optical system 254 and sending optical system 256 so as to scan the interrogation beam over a selected region on the target surface (for laser radar, beam scanning is usually one or both of azimuth and elevation), (e) a receiving optical system 262 that receives light 257 (from the interrogation beam 255) reflected from the target back to the system 250 (the receiving optical system 262 includes a photodetector, not detailed, that produces an electronic signal corresponding to the received light 257), and (f) a signal-processing system that converts the signal from the photodetector into usable data concerning the scanned region of the target. The beam-shaping optical system 254 and sending optical system 256 collectively have large mass, which limits the rate at which the scanning device 260 can move them. I.e., the maximum achievable beam-scanning rate is adversely affected by the mass that must be moved by the scanning device 260. The resulting compromised scanning rate can limit the rate at which the system 250 produces information about the target.

Therefore, there is a need for beam-scanning systems of which the mass that is actually moved to achieve scanning of the beam is substantially less than in conventional systems, and hence are less limited in the rates at which the beam can be moved in a scanning manner.

### SUMMARY

The needs articulated above are met by systems and methods as disclosed herein, of which a first aspect is directed to optical systems. An exemplary embodiment of an optical system comprises a beam-forming unit, a beam-scan unit, and a controller. The beam-forming unit comprises a first optical element, and the beam-scan unit comprises a second optical element. The first optical element is movable to shape and direct an optical beam along a nominal propagation axis to a target, and the second optical element comprises at least one movable beam deflector that moves the optical beam in a scanning manner relative to the nominal propagation axis. The controller is coupled to the beam-forming unit and beam-scan unit and configured to induce movement of the first optical element required for shaping and directing the optical beam along the nominal propagation axis and to induce movement of the beam deflector of the second optical element as required to scan the optical beam relative to the nominal propagation axis. In many embodiments the second optical element comprises a rotary actuator coupled to the controller and to which the second optical element is coupled, wherein the controller is configured to actuate the rotary actuator as required to rotate the optical beam.

The system can further comprise a transmit/receive system coupled to the controller and configured to send the optical beam to the target and to receive at least a portion of the optical beam as reflected from the target. The transmit/receive system can further comprise a source of the optical beam. For example, the source comprises a laser.

It is desirable for the motion of the second optical element to be independent of motion of the first optical element so that the scanning mass may be minimized. The first optical element can be used to adjust one or more of: width of the beam, shape of the beam, and direction of the beam.

In many embodiments the first optical element is a reflective optical element. Desirably, the reflective optical element is a corner cube situated to receive the optical beam from a light source. The second optical element can be a refractive optical element (e.g., a wedge prism) or a reflective optical element (e.g., a mirror) situated to receive the optical beam from the corner cube and configured to return the optical beam to the corner cube as the second optical element is being moved relative to the corner cube.

The beam-forming unit can further comprise a focus-adjust device, while the beam-scan unit further comprises a movement-adjust device. In certain embodiments the focus-adjust device is coupled to the first optical element and to the controller to move the first optical element as required to focus the optical beam on the target. Meanwhile, the movement-adjust device is coupled to the second optical element and to the controller to adjust at least one parameter associated with movement of the beam deflector. The beam-forming unit can further comprise a reflective optical element, wherein, for example, the focus-adjust device adjusts a linear position of the reflective optical element as required to focus the optical beam on the target.

Another embodiment of an optical system comprises a beam-shaping optical system, a movable beam deflector, and a beam-scan controller. The beam-shaping optical system produces an optical beam. The movable beam deflector directs the optical beam to a target. The beam-scan controller is operably coupled to the beam deflector to produce an optical-beam scan angle based on an orientation of at least a portion of the beam-shaping optical system and an angle (e.g., rotation angle) of the beam deflector. Certain embodiments are configured as a laser radar system, wherein the optical beam is an interrogation beam.

The beam-scan controller desirably is configured to establish a plurality of scan angles such that the optical beam is scanned in a desired scan pattern as incident on the target. In certain embodiments the beam-scan controller is configured to direct the optical beam in a pointing direction based on an orientation of at least a portion of the beam-shaping optical system, wherein the beam deflector has an axis of rotation that is parallel to the optical-beam pointing direction.

In many embodiments the rotatable beam deflector comprises at least one rotatable wedge prism or rotatable mirror. The rotatable wedge prism or mirror can be situated so that the optical beam produced by the beam-shaping optical system is incident at an angle to the prism or mirror corresponding to a minimum deviation by the prism or mirror.

In some embodiments the beam deflector is rotatable, comprising a rotation stage, with a rotatable optical element being coupled to the rotation stage.

The movable beam deflector can comprise a first rotatable wedge prism having a first wedge angle and a second rotatable wedge prism having a second wedge angle. In some embodiments the first wedge angle and the second wedge angle are equal. The systems can further comprise first and second rotation stages coupled to the first and second rotatable wedge prisms, respectively.

Certain embodiments further comprise an optical detection system that is configured to receive at least a portion of the interrogation optical beam from the target and to produce a target assessment based on the received portion. The target assessment can be associated with a target distance or a target shape. The beam-scan controller can be configured to establish an interrogation-beam pointing direction based on an orientation of at least a portion of the beam-shaping optical system and to rotate the scan angle about the pointing direction so as to define a scan path. The target assessment produced by the optical detection system in these embodiments can be at least one of a target dimension or a target surface profile.

Some embodiments further comprise an optical detection system configured to receive at least a portion of the interrogation optical beam from the target and to produce a target assessment based on the received portions and the associated scan angles. The beam-scan controller can be configured to establish an interrogation optical beam pointing direction based on an orientation of at least a portion of the beam-shaping optical system and to rotate the scan angle about the orientation so as to define a scan path, wherein the target assessment produced by the optical detection system is at least one of a target feature dimension or target feature location.

According to another aspect, methods are provided. An embodiment of the method comprises establishing a beam orientation of an optical beam along a nominal propagation axis using a beam-shaping optical system. The optical beam is scanned about the nominal propagation axis using a movable beam deflector. The scanned beam is delivered to a target. At least a portion of the beam back from the target is received, and a characteristic of the target is determined based on the received portion.

By way of example and not intending to be limiting, the beam can be scanned along a circular path relative to the nominal propagation axis. The range of possible scan patterns is substantially unlimited.

The method can further comprise adjusting the optical beam orientation based on the determined target characteristic, and re-determining the target characteristic. Additionally the orientation of the optical beam can be established with respect to a selected target feature, wherein, using the beam deflector, the optical beam is scanned about the selected target feature.

In many embodiments the movable beam deflector comprises a refractive optical element such as but not limited to a wedge prism, wherein scanning of the optical beam is produced by deviating the optical beam by transmission through the wedge prism. The wedge prism can be situated at an angle associated with a minimum optical beam deviation. Alternatively, the movable beam deflector comprises a reflective optical element.

According to another aspect, apparatus are provided, of which a representative embodiment comprises a beam-forming optical system, a primary beam scanner, a secondary beam scanner, and an optical detection system. The beam-forming optical system is configured to produce an optical beam. The primary beam scanner is situated and configured to produce a primary scan of the optical beam, using the beam-forming optical system. The secondary beam scanner is situated and configured to receive the optical beam from the primary beam scanner and produce a secondary scan, such that the scanning optical beam is directed along a scan path defined by the primary and secondary beam scanners. The optical detection system is configured to estimate target distances associated with at least a portion of the scan path based on portions of the optical beam received from the target. The apparatus can further comprise a scan controller configured to establish the primary scan based on an at least one target distance produced by the optical detection system.

In many embodiments the secondary beam scanner includes at least one wedge prism (as an exemplary refractive optical element) situated to receive the optical beam from the primary beam scanner and transmit the received optical beam along the scan path. The secondary beam scanner can include at least a first wedge prism and a second wedge prism. The first wedge prism in many examples is situated and configured to receive the optical beam from the primary beam scanner and to transmit the received optical beam to the second wedge prism. Meanwhile the second wedge prism can be situated and configured to transmit the optical beam from the first wedge prism along the scan path.

According to another aspect, laser radar apparatus are provided. An embodiment of such an apparatus comprises an optical fiber situated to emit an optical beam along an axis. A corner cube is situated along the axis so as to receive the emitted optical beam. A displacement stage is coupled to the corner cube and configured to displace the corner cube along the axis. A return reflector is situated along the axis to receive the emitted optical beam from the corner cube and reflect the emitted optical beam as a returned beam to the corner cube. A beam-forming lens is situated along the axis to receive the returned beam from the corner cube and produce an interrogation beam. A focus controller is coupled to the displacement stage and configured to adjust a separation of the corner cube and the beam forming lens so as to focus the interrogation beam at a selected target distance. A primary beam scanner is configured to direct the axis toward a selected target location. A secondary beam scanner coupled to produce a motion of a scanning optical element so as to produce an angular deviation of the interrogation beam with respect to the axis so as to define a scan path.

In some embodiments the laser radar further comprises an optical receiver system configured to detect at least portions of the interrogation optical beam returned from a target, and a processor. The processor is coupled to the optical receiver systems and configured to determine a target characteristic for at least a portion of the target based on the detected portions of the interrogation optical signal and the scan path. The laser radar can further comprise a movable optical element (e.g., a rotatable wedge prism or mirror), wherein the secondary beam scanner is coupled to produce a motion of the optical element. The laser radar can further comprise a rotatable reflective surface, wherein the secondary beam scanner is coupled to produce a rotation of the rotatable reflective surface.

Thus, among the aspects described herein, laser radar and other precision systems are provided that comprise a beam-shaping optical system configured to produce an interrogation optical beam that can be scanned over a small angle using a lightweight movable beam deflector. Using this movable beam deflector allows beam scanning to be performed without having to move the primary optical assembly and associated mechanics. Such a beam deflector can be situated to receive the interrogation optical beam from the beam-shaping optical system and direct the interrogation optical beam to a target for scanning while the beam-shaping optical system remains fixed. A beam-scan controller establishes an interrogation-beam scan angle based on the orientation of at least a portion of the beam-shaping optical system and the posture of the beam deflector. In some embodiments, the beam-scan controller is configured to establish a plurality of scan angles such that the interrogation optical beam is scanned in an ellipse, a circle, a polygon, a w-shape, or in at least a portion of an arc, for example. In other embodiments, the beam-scan controller is configured to establish an interrogation-beam pointing direction based on an orientation of at least a portion of the beam-shaping optical system. In typical examples, the beam deflector comprises at least one rotatable wedge prism or other refractive optical element, or a rotatable mirror. In other representative examples, the optical element is situated so that the interrogation beam produced by the beam-shaping optical system is incident at an angle corresponding to a minimum deviation angle by the rotatable wedge prism.

In other representative examples, the rotatable beam deflector comprises a first rotatable wedge prism having a first wedge angle and a second rotatable wedge prism having a second wedge angle, wherein the first wedge angle and the second wedge angle can be the same or different. In some convenient embodiments, the first and second wedge prisms are rotatable so that the interrogation beam can be transmitted without deviation if desired.

The foregoing and additional features and advantages will be more readily understood from the following description, which proceeds with reference to the accompanying drawings.

### BRIEF DESCRIPTION OF THE DRAWINGS

FIG. 1 is a block diagram of an embodiment of an optical system configured to scan a substantially collimated light beam over a region of interest on a target.

FIG. 2 is a block diagram of an alternative embodiment of an optical system configured to scan a substantially collimated light beam over a region of interest on a target.

FIG. 3 is a schematic diagram of an embodiment of an optical system configured to scan a substantially collimated light beam over a region of interest.

FIG. 4A is a schematic diagram of an embodiment of a wedge-prism scanning assembly comprising two prisms.

FIG. 4B is a schematic diagram of an embodiment of a wedge-prism scanning assembly comprising a wedge prism situated at a minimum deviation angle.

FIG. 4C is a schematic diagram of an embodiment of a wedge-prism scanning assembly in which the wedge prism is situated on a tiltable base that provides beam scanning.

FIG. 5 is a block diagram of an embodiment of a method for evaluating a target using a scanned beam.

FIG. 6 is a schematic diagram of an embodiment of a laser radar system comprising a primary beam scanner and a secondary beam scanner based on a rotatable reflective surface.

FIG. 7 is a schematic diagram of an alternative embodiment of a scanning device based on rotation of a return mirror.

FIG. 8A is a schematic diagram of an embodiment of a laser tracking system comprising a rotatable beam deflector.

FIGS. 8B-8C depict representative rotatable beam deflectors suitable for the laser tracking system of FIG. 8A.

FIG. 9A is a schematic diagram of an embodiment of a secondary scanner comprising a beam deflector that is translatable so as to deflect a beam from a laser tracking system.

FIG. 9B details facets of the beam deflector shown in FIG. 9A.

FIG. 10 is a schematic diagram of an embodiment of a laser tracking system comprising a secondary scanner.

FIG. 11 is a schematic diagram of a representative embodiment of a secondary scanner based on a rotatable prism.

FIG. 12 is a schematic diagram of a representative embodiment of a secondary scanner based on a rotatable prism that serves as a return reflector.

FIG. 13 depicts an exemplary rotatable prism configured to serve as a beam deflector and a return reflector based on reflection from a back surface of the rotatable prism.

FIG. 14 is a schematic diagram of an embodiment of a secondary scanner based on a rotatable prism that is situated at a return reflector.

FIG. 15 is a block diagram of a representative embodiment of a method for tracking a tooling ball secured to a substrate or target.

FIG. 16 is a block diagram of a representative embodiment of a manufacturing system comprising a laser radar or other profile-measurement system for use in manufacturing components and for assessing whether the manufactured parts are defective or acceptable.

FIG. 17 is a block diagram of a representative embodiment of a manufacturing method comprising profile measurement to determine whether manufactured structures or components are acceptable, and whether one or more such manufactured structures can be repaired.

FIG. 18 is a schematic diagram of a conventional laser radar system.

### DETAILED DESCRIPTION

The invention is described below in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, apparatus, and methods are not limited to any specific aspect or feature or combinations thereof, nor do the disclosed systems, apparatus, and methods require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to a target or other object, an “upper” surface can become a “lower” surface simply by turning the target over. Nevertheless, it is still the same object.

The systems, apparatus, and methods described herein should not be construed as being limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation set forth herein are to facilitate explanation; but, the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience in the following description, the terms “light” and “optical radiation” refer to propagating electromagnetic radiation that is directed to one or more targets or other loci to be profiled, detected, or otherwise investigated. Such radiation can be referred to as propagating in one or more “beams” that typically are based on optical radiation produced by a laser. In addition, such beams can have a spatial extent associated with one or more laser transverse modes, and can be substantially collimated and/or focused. As used herein, a beam having a wavelength λ is “substantially collimated” if an associated beam divergence (or convergence) angular diameter β is less than about 0.05, 0.01, or 0.005. In some examples, a substantially collimated beam has a divergence or convergence such that a ratio of a beam diameter at a target to a beam diameter as emitted to the target is less than 2:1, 1.5:1 or 1.2:1. Alternatively, collimation can be associated with beams such that a source-to-target distance is less than about 0.5, 1.0, 2.0, or 4.0 times a Rayleigh range associated with the beam.

For convenience, beams are described as propagating along one or more axes. Such axes generally are based on one or more line segments so that an axis can include a number of non-colinear segments as the axis is bent or folded or otherwise responsive to mirrors, prisms, lenses, and other optical elements. The term “lens” is used herein to refer to a single refractive optical element (a singlet) or a compound lens that includes one or more singlets, doublets, or other elements. In some examples, beams are shaped or directed by refractive optical elements; but, in other examples, reflective optical elements such as mirrors are used, or combinations of refractive and reflective elements are used. Such optical systems can be referred to as dioptric, catoptric, and catadioptric, respectively. Other types of refractive, reflective, diffractive, holographic and other optical elements can be used as may be convenient.

“Rotation,” unless otherwise specified, refers to rotation about any axis that provides the desired result. Many of the embodiments described below utilize an optical element that is rotated about the optical axis. Rotation about an axis that is perpendicular to the optical axis is also called “tilt.” Rotation about the remaining orthogonal axis is also called “tip.”

In typical embodiments described below, a rotatable wedge element is situated at a suitable location in a beam path. The wedge element typically deflects the beam from its propagation axis typically by less than about 1 mrad, 2 mrad, 5 mrad, 10 mrad, 50 mrad, 100 mrad, or 500 mrad. Rotating the wedge element about the beam propagation axis can then sweep the beam along a closed path such as a circle or ellipse. In other examples, a scan path can be a polygon, or portions of such closed curves. Alternatively, a beam scan can be a raster scan, a vector scan, a w-pattern, and scanning can be periodic or aperiodic. The examples below are provided with respect to a laser radar that is configured to, for example, provide an estimate of surface topography based on portions of an optical beam directed to a surface that are returned to a receiver. The disclosed method and apparatus can also be incorporated into laser tracker systems.

Some described embodiments include a corner cube used as part of a focus system. For convenient illustration, such corner cubes are shown in some figures as two reflectors having reflective surfaces at 90° with respect to each other.

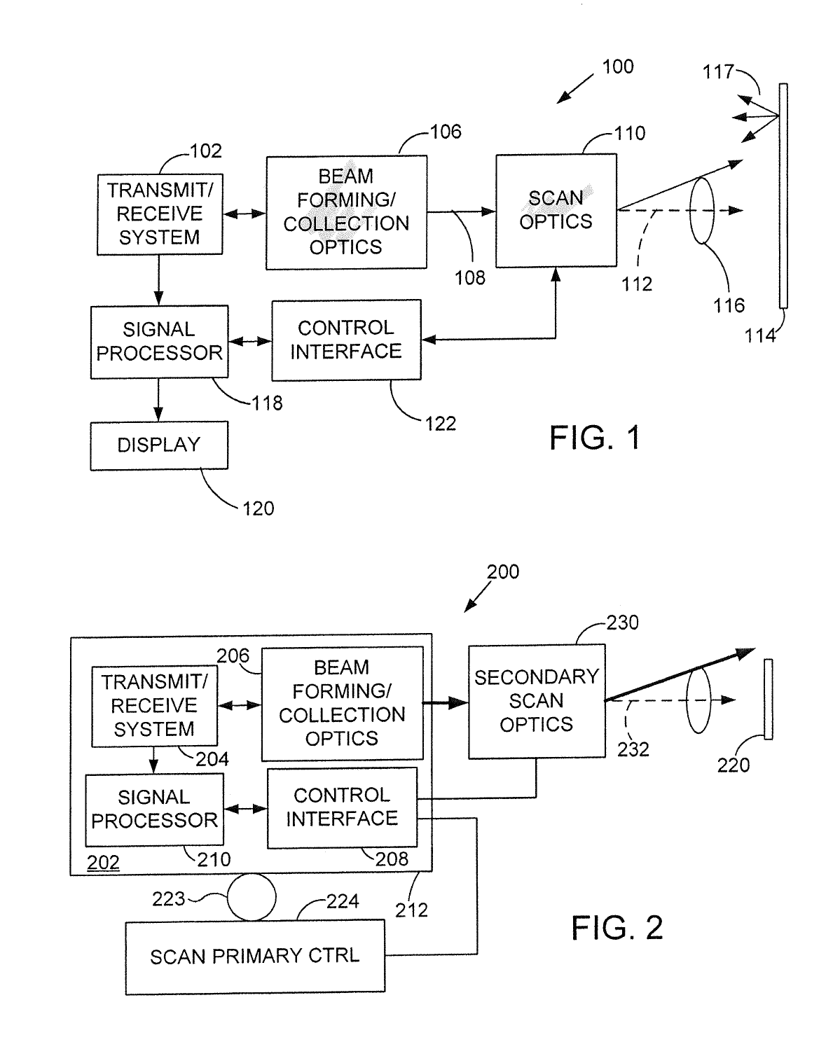

A representative embodiment of a laser radar 100 (as an exemplary optical system) is illustrated in FIG. 1. A transmit/receive system 102 produces one or more optical beams that interact with a beam-forming unit 106 and with a beam-scan unit (“scan optics”) 110. The beam-forming unit 106 also generally serves as a beam-collection unit. The beam-forming unit 106 produces an optical beam 108 that is directed to the beam-scan unit 110. The optical beam typically includes a measurement beam at a first wavelength and an alignment beam at a second, visible, wavelength. As shown in FIG. 1, the optical beam 108 is directed along an axis 112 (called a “nominal propagation axis”) to a target 114 in the absence of being deflected by the beam-scan unit 110. Typically, the beam-scan unit 110 is configured to produce an angular deflection of the optical beam 108 so that the optical beam assumes a circular or other scan path 116 relative to the nominal propagation axis 112.

Scattered, reflected, or other portions 117 of the optical beam 108 (at least of the measurement beam) return to the transmit/receive system 102 via the beam-scan unit 110 and the beam-forming unit 106. Detected signals based on the returned beam portions are routed to a signal processor 118, which produces measurements of a target surface that can be provided to a display 120. In some examples, the detected signals are processed to provide target-surface assessments or determine target-surface characteristics without needing to produce a display image. The beam-scan unit 110 and the signal processor 118 are generally coupled to a control interface 122 so that beam scanning can be correlated with corresponding detection signals. The control interface 122 can also be configured to permit a user to input selected scan ranges, scan rates, surface data assessments, or other measurement configurations.

With reference to FIG. 2, a second embodiment of an optical system 200 is shown that can be used as a laser radar system. The system of this embodiment comprises a module 202 including a transmit/receive system 204, a beam-forming unit 206, a control interface 208, and a signal processor 210, all secured to a common support 212. A secondary beam-scan unit (“secondary scan optics”) 230 is also secured to the common support 212. The optical system 200 can be secured to one or more rotational stages 223 such as a gimbal system. An optical beam (or combination of measurement and alignment beams) can be directed (as controlled by the primary beam-scan unit 224; denoted “scan primary ctrl”) along a nominal propagation axis 232 toward a target 220. The combined measurement and alignment beams can be scanned over the target 220 using the stage 223, but the relatively large mass of the stage and anything mounted to it generally limits scan speeds. The system 200 also includes the secondary beam-scan unit (“secondary scan optics”) 230 that receive the beam(s) from the module 202 and scans the beam(s) relative to the nominal propagation axis 232.

It will be understood that FIG. 2 depicts an embodiment that is not intended to be limiting. For example, it is not necessary that the control interface 208, the signal processor 210, the beam-forming unit 206, or even the transmit/receive system 204, in any combination, be situated on or in the laser radar module 202. One or more of these assemblies can be provided, for example, as respective stationary (or independently placeable) unit(s). In addition, it is not necessary that any of the control interface 208, the signal processor 210, the beam-forming unit 206, or the transmit/receive system 204 be movable at all. Optical interconnections and electrical interconnections among the assemblies can be readily made using flexible optical cable and flexible electrical cable as needed. Similarly, electrical and optical interconnections between the secondary scan optics 230 and any other unit of the system 200 can be made using flexible fiber-optic cables, for example.

A third representative embodiment of an exemplary optical system, configured as a laser radar system, is illustrated in FIG. 3. The beam-forming unit comprises an optical fiber 302 including an emitter surface 304 that produces an optical beam 306 directed to a corner cube 308 (as an exemplary reflective optical element of the beam-forming unit). The optical fiber 302 is coupled by a beam splitter 305 to a transmit (“TX”) system 303. The transmit system 303 includes one or more lasers or other suitable light sources (not shown in FIG. 3). It is generally convenient to select the optical fiber 302 and the measurement-beam wavelength so that the optical beam emitted by the optical fiber 302 propagates in a lowest-order mode of the fiber; but, higher order modes can alternatively be used. An alignment beam can be similarly produced and selected by these components. In some examples, the fiber 302 is selected to be single mode at about 1550 nm so that a 1550-nm measurement beam propagates in a single, lowest-order mode and the visible alignment beam propagates in only a few fiber modes. A receiver (“RX”) system 307 is coupled by the beam splitter 305 to the optical fiber 302. The beam splitter is shown for convenience as a cubic beam splitter; but, it will be understood that other arrangements including fiber couplers can be used instead.

The optical beam 306 emitted from the optical fiber 302 is typically not collimated, propagating with an angular diameter of about two times the numerical aperture of the optical fiber. The corner cube 308 directs the emitted beam to a reflector 310, from which the beam is reflected back through the corner cube along a nominal propagation axis 312 to a beam-forming lens 314. The corner cube 308 is secured to a translation stage 318 that is movable under the direction of a focus controller 320. Adjustable displacement of the corner cube 308 along the axis 312 permits focusing of the optical beam on the target.

The embodiment of FIG. 3 also includes a beam-scan unit comprising a wedge prism 324 that is secured to a rotational stage 325 and situated to receive the optical beam from the lens 314. The prism 324 deflects the optical beam along a scan axis 328 relative to the nominal propagation axis 312. The orientation of the scan axis 328 can be varied based on the rotational angle of the prism 324 relative to the nominal propagation axis 312. In some examples, the prism 324 is situated at a so-called minimum deviation angle, wherein the prism wedge angle β can be selected to produce a suitable deflection. The rotational stage 325 is situated and configured so that the prism 324 can be rotated about the nominal propagation axis 312 while the rotational axis of the rotation stage 325 is tilted relative to the axis 312. An encoder 331 can be provided for measuring rotation angles.

To achieve scanning motion of the optical beam(s), the entire optical system of FIG. 3 could be moved in a scanning manner (an electromechanical system for producing such scanning is not shown in FIG. 3, but see the discussion above regarding FIG. 2). Having to move the entire system to produce scanning motion of the beam(s) limits the achievable scanning rate and scanning accuracy and precision due to the system's relatively high mass. Instead, in this embodiment, scanning motion of the beam is achieved by rotating the wedge prism 324 relative to the rest of the system, which allows production of correspondingly higher scan rates.

Whereas the wedge prism 324 can be controlled so as to be rotated at a fixed or variable frequency, the wedge prism 324 can also be controlled to achieve scanning over fixed or variable segments of an arc. Portions of the optical beam received at the receive system 307 can be associated with a particular portion of a target based on a synchronization signal supplied by a rotation controller 330. Alternatively, an image processor that is coupled to receive and process detection signal data from the receive system 307 can provide synchronization signals that are received by the rotation controller 330 and used to select wedge-prism rotations.

As shown in FIG. 3, rotation of the wedge prism 324 produces corresponding beam rotation 331 about the nominal propagation axis 312. Alternatively, other optical elements can be used to produce similar rotations, such as (but not limited to) ruled diffraction gratings, holographic gratings, achromatic prisms, and other elements. In addition, one more additional wedge prisms can be situated so as to rotate or deflect the optical beam further. These additional prisms can have a common wedge angle or different respective wedge angles, and an image processor can be configured to associate detected optical radiation with corresponding locations in a region of interest based on the orientation of the prisms and their respective prism angles.

In an alternative configuration, the wedge prism 324 is replaced with a mirror that is mounted to the rotation stage 325 so as to receive light flux from the lens 314 and reflect the light flux downstream toward a target surface. In this alternative configuration, rotation of the mirror by the rotation stage 325 produces a corresponding scanning motion 331 of the beam. Hence, in the secondary scan system of this alternative configuration, the rotatable wedge prism 324 is replaced by a rotatable mirror, but the other components are the same as shown in FIG. 3.

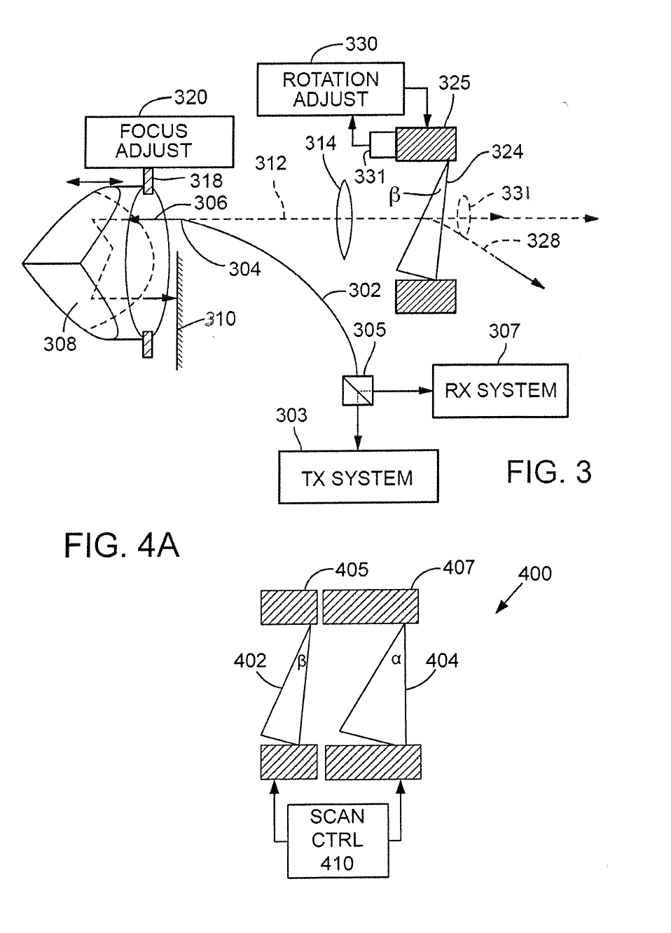

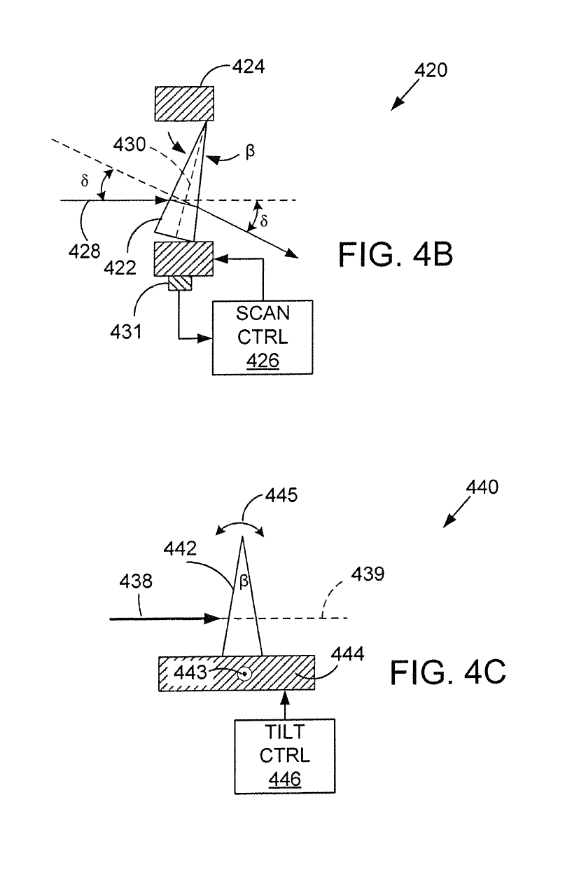

Referring now to FIG. 4A, another embodiment of a secondary scan system 400 comprises a first prism 402 and a second prism 404 having respective prism wedge angles α, β. The prisms 402, 404 are secured to respective rotational stages 405, 407 that are individually rotatable under the control of “scan ctrl” 410. In some orientations, deflections produced by the prisms 402, 404 are additive along a single direction, while in other orientations, the scan deflections are along orthogonal or non-parallel axes so that more complex scan patterns and larger scan patterns can be produced. If the prisms 402, 404 are selected so that the prism angles α=β, then the prisms 402, 404 can be oriented to produce substantially zero deflection. The first prism 402 and the second prism 404 can be collectively rotated about a common axis or rotated about different respective axes to produce varying scan patterns. For example, the rotational stages 405, 407 can be situated to provide associated selected scan angles, and the rotational stages 405, 407 can be independently rotatable.

It will be understood that one or both prisms 402, 404 can be replaced with a respective mirror mounted to a respective rotational stage and rotated to impart a desired scanning motion to the beam propagating to a target or the like.

FIG. 4B illustrates an embodiment of a wedge-prism assembly 420 that comprises a wedge prism 422 secured to a rotational stage 424. A scan controller (“scan ctrl”) 426 is configured to adjust the rotational angle δ of the rotational stage 424 as required to produce a desired scanning motion of an optical beam 428 passing through the assembly. The wedge prism 422 is situated so that a deflection angle δ of the input optical beam 428 can be obtained from nₚᵣᵢₛₘ=sin(δ+β)/2/sin β/2, wherein β is wedge angle and nₚᵣᵢₛₘ is index of refraction of the wedge prism 422. At the angle of minimum deviation, the input optical beam 428 is refracted so as to propagate perpendicularly to a bisector 430 of the wedge angle β. One or more rotary encoders such as encoder 431 can be coupled to the rotational stage 424 to provide measurements of the current angle of rotation. The measurement data are provided to the scan controller 426 so that beam scanning can be controlled and/or the rotation angle measured. Again, it will be understood that the wedge prism 422 can be replaced with a mirror that is rotatably mounted and adjustable in a similar manner.

FIG. 4C illustrates a portion of a wedge prism assembly 440 configured to scan an input optical beam 438 relative to an axis 439 by tilting a wedge prism 442 about an axis 443. The wedge prism is adjustably mounted to produce tilting of the prism apex as shown at 445. In this example, the input optical beam 428 is generally not incident to the wedge prism 442 at the minimum deviation angle. Again, it will be understood that the wedge prism 442 can be replaced with a mirror.

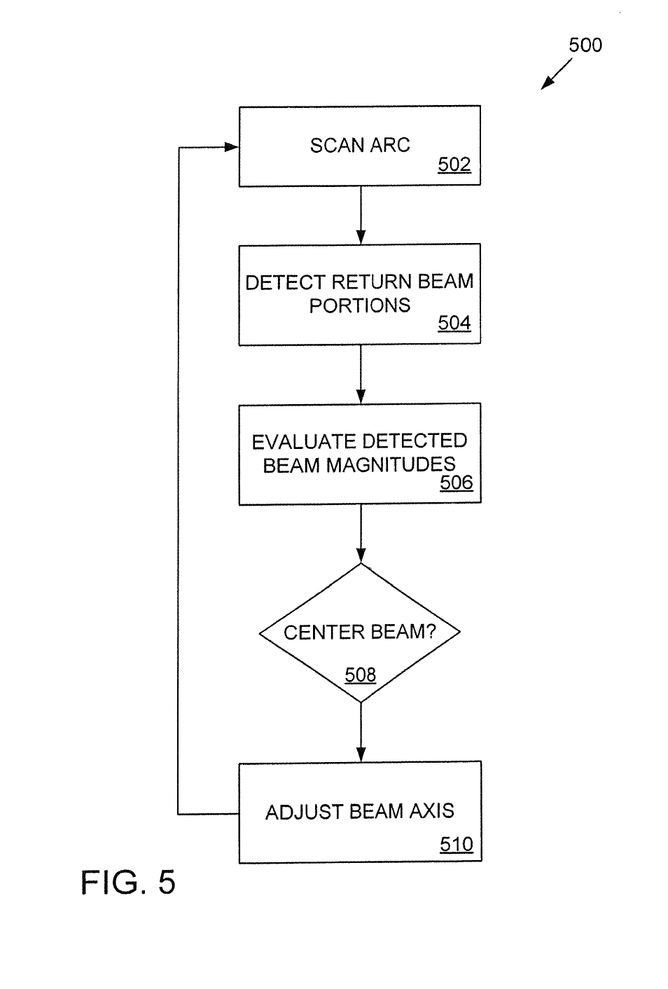

A representative embodiment of a measurement method is illustrated in FIG. 5. At 502, an optical beam is scanned along an arc or other scan path using, for example, a rotating wedge element. At 504, returned portions of the optical beam are detected, and magnitudes or other characteristics of the returned beam are estimated. At 506, the detected portions are evaluated to determine possible surface features. In some examples, spherical or circular target features are of interest, and a center location of a target circle or sphere can be estimated based on signal characteristics. If beam centration is determined to be of interest at 508, then the beam position is adjusted at 510. Typically, beam adjustment is accomplished by movement of components other than a rotating wedge, such as by rotating the laser radar optical system on one or more stages; but, a wedge can be used if desired. After beam adjustment, beam scanning continues at 502.

Measurements produced by the method 500 can be used to produce an average measurement over a small patch of a target surface. Alternatively, the measurement data can be analyzed to determine surface orientation at a measurement location. By monitoring return-signal intensity around the circular scan, deviations from a center location or a particular location on the target can be estimated so that the measurement beam can be maintained in alignment with a specific target-surface location. In other examples, wedge scanning can be used to increase measurement quality, accuracy, or rate, or to track particular surface features. In some examples, wedge-based scanning can be used exclusively.

In typical applications, a secondary beam scanner is used to track a target feature. Based on the beam-displacement needed, a primary beam scanner can be adjusted so that beam scanning remains within a preferred range of primary scan angles of the scanner, typically near a center of a primary scanner scan pattern or scan range.

In the embodiments of laser radar systems disclosed above, scattered, reflected, or other portions of a scanned optical beam are returned to a transmit/receive system. Detected signals based on the returned beam portions are coupled to a signal processor and used to form a target-surface image or contour map. Corresponding data can be provided to a display. In some examples, the detected signals are processed to provide target-surface assessments without producing a displayed image. The scanning wedge (and/or scanning mirror) and the signal processor are generally coupled to a control interface so that beam scanning can be correlated with a corresponding detection signal. The control interface can also be configured to permit user inputs to select scan ranges, scan rates, surface data assessments, or other measurement configurations. Typically, wedge rotations and/or scanned beam locations can be monitored during a scan using one or more encoders or other monitoring systems, but these are not shown in some figures. In some examples, detection of beam deflection or wedge rotation is not needed due to stable, open-loop scan performance and/or calibration that can be performed at occasional intervals. However, real-time tracking of beam scan and the associated scan elements can be advantageous.

Some features of the embodiments discussed allow beam steering without using the rotary axes of a laser radar. Since the steering element (a wedge and/or mirror) can be small and low in mass, it can be moved more easily and quickly than otherwise achieved by rotation about main rotary axes, and so tends to allow quicker scans in the vicinity of a given measurement point. This could be used for producing spiral or w-scans, for example. In addition, different measuring strategies can be implemented such as, for example, averaging a number of points around a selected measurement point to get a better estimated value, or determining surface orientations on a small patch. Monitoring the intensity of a return signal as a beam is moved can give an indication of centering of a tooling ball relative to a measurement beam. These features may increase measurement quality, accuracy, or rate, and can be used for a tracking function, so that a laser radar system as disclosed herein can mimic at least some laser-tracker functionality.

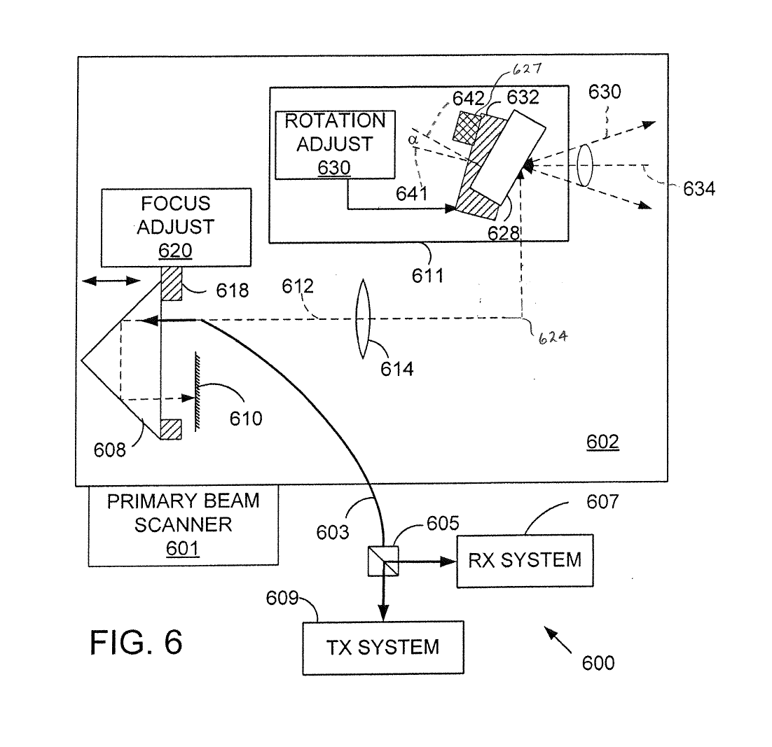

An embodiment of a laser tracking or laser radar system 600 (as an exemplary optical system) that includes a primary beam scanner 601 and a secondary scanner 611 is illustrated in FIG. 6. The primary scanner 601 is mechanically coupled to an optical system 602 that is configured to move an optical beam(s) introduced by an optical fiber 603. The optical system 602 comprises a corner cube 608 situated to direct the beam emitted from the fiber 603 to a reflector 610. The reflector 610 reflects the beam back through the corner cube 608, from which the beam propagates along an axis 612 to a beam-forming lens 614. The corner cube 608 is coupled to a translation stage 618 that is movable under the direction of a focus controller (“focus adjust”) 620. Displacing the corner cube 608 along the axis 612 focuses the optical beam on a target, for example. Alternatively to using a corner cube, focus adjustments can be made using other optical and/or opto-mechanical devices.

In this embodiment the optical fiber 603 is coupled to a transmit system (“TX system”) 609 via a beam splitter 605. The transmit system 609 typically includes one or more lasers or other light-beam sources (not shown) that produce optical beams. A receiver system (“RX system”) 607 is also coupled to the optical fiber 603 via the beam splitter 605. The beam splitter shown in FIG. 6 is shown as a cubic beam splitter for convenience; alternatively, other arrangements including use of fiber couplers can be used.

The system 600 is depicted in FIG. 6 as having a bend 624 in the axis 612 between the lens 614 and the secondary scanner 611 to indicate that the axis 612 (indeed, substantially any optical axis) is not necessarily linear over its entire length. Rather, the axis can be bent by encountering a change in reflective or refractive surface using, for example, a mirror or prism (not shown) as desired or required. Alternatively, all or a portion of the propagation pathway of a beam of light can be provided by an optical fiber, for example, by which bends and curves in the axis can be conveniently made. (Note the optical fiber 603 coupled to the beam splitter 605.) In FIG. 6, the bend 624 is also made to accommodate the manner in which the secondary scanner 611 is depicted in the figure.

The secondary beam scanner 611 is situated along the axis 612 to receive the beam from the lens 614 for scanning. The secondary beam scanner 611 includes a reflective surface 628 (shown in FIG. 6 as a mirror surface). The reflective surface 628 is coupled to a tiltable mount 632, having a tilting axis 641, being tiltable via an actuator 627, and being controlled by a “rotation adjust” controller 630. The axis 641 is tilted with respect to an axis 642 that is perpendicular to the reflective surface 628 or oriented relative to the reflective surface by an angle α, such that the axes 641, 642 are not parallel to each other. Smaller values of α produce smaller beam deviations in response to rotations. The reflective surface 628 deflects the optical beam based on the rotational angle of the reflective surface 628 about the axis 641. The optical beam reflected from the rotating reflective surface 628 propagates along scan axes 630 relative to the nominal propagation axis 634.

While the reflective surface 628 can be controlled so as to be rotated at a fixed or variable frequency, the surface can also be configured to provide scans over arcs, line segments, or closed curves such as ellipses, circles, and polygons, for example. Portions of the optical beam received at the receiver system 607 can be associated with a particular portion of a target based on a synchronization signal supplied by a rotation-adjust controller 630. Alternatively, an image processor that is coupled to receive and process detection signal data from the receive system 607 can provide synchronization signals that are received by the rotation-adjust controller 630 and used to select rotations. One or more reflective surfaces can be provided based on prism surfaces, mirror surfaces, or other reflective surfaces.

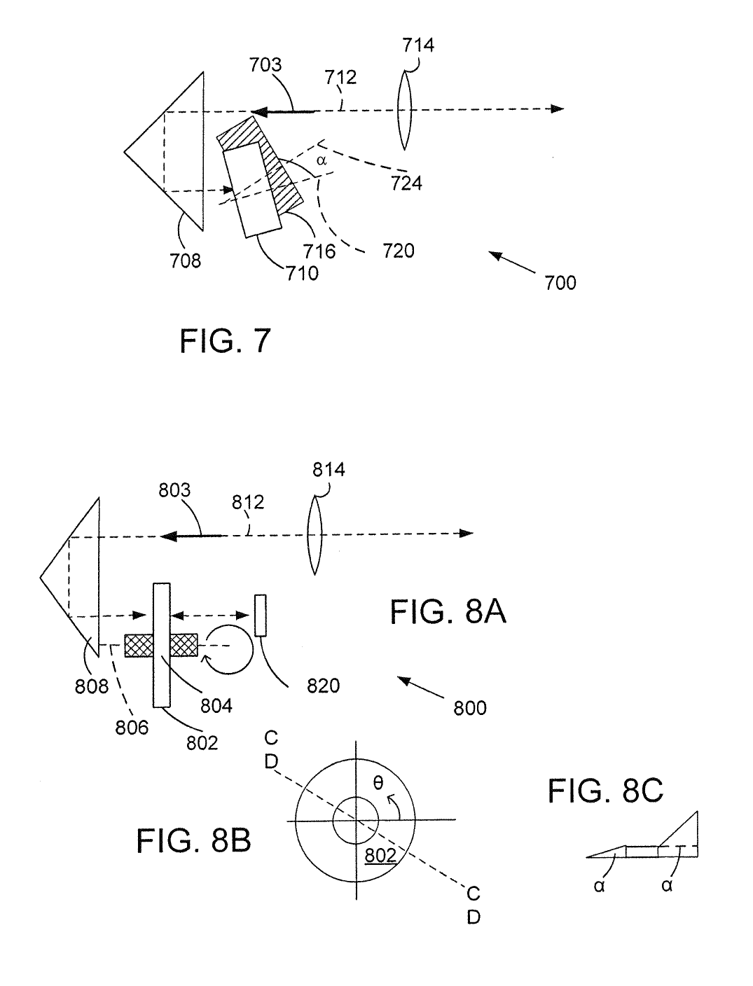

FIG. 7 illustrates a portion of an embodiment of an optical system 700 that is configured to direct an optical beam 703 along a nominal propagation axis 712. The optical beam 703 is incident to a corner cube 708 and to a return reflector 710, and is focused by an objective lens 714 onto a target. The return reflector 710 is secured to a rotatable stage 716 that is configured to rotate about an axis 724. The reflector 710 has a surface mirror 720 that is tilted at an angle α with respect to the axis 724. Rotation of the reflector 710 thus causes beam scanning. In this embodiment the tilt need not be constant; the reflector 710 can readily be mounted to the stage 716 in a manner allowing the tilt to be adjusted. In addition, the reflector 710 can be readily made to simply tip and tilt about respective axes that are orthogonal to the axis 712.

Turning now to FIG. 8A, an embodiment of a secondary scanning system 800 includes a rotatable beam deflector 802 that is situated on a shaft 804 that rotates the deflector about an axis 806. An optical flux 803 to be formed into a beam and scanned is directed along a nominal propagation axis 812 to a corner cube 808 or other reflector, and directed through the beam deflector 802 to a return mirror 820. The return mirror 820 directs the optical flux along the axis 812, but at a fixed or variable scan angle, to a lens 814 to produce a beam that is directed to and scannable on a target. The beam deflector 802 is transparent to the optical flux 803 and is sufficiently large to accommodate substantially the entire beam width associated with the optical flux. The beam deflector 802 can be rotated continuously at a fixed or variable rate, or stepped to a particular location to produce a selected deflection. One or more encoders can be provided for measuring rotation, and two or more beam deflectors can be configured to rotate at different rates about the same or different axes, thereby producing deflections that differ in magnitude and/or direction.

In one example, the beam deflector can be a transparent disc having a variable prism-wedge angle as shown in FIG. 8B. The prism-wedge angle α can be any of various functions of an angular coordinate θ, i.e., α=α(θ), such as a linear, non-linear, or periodic function of θ. The prism wedge can be directed along a radius, directed orthogonally to a radius, or in other directions. A periodic variation in wedge angle can be used so that a scan pattern repeats more than once during a single rotation of the beam deflector 802. For example, a selected variation in wedge angle can occur once, twice, or N times per rotation, wherein N is a positive number, or conveniently, an integer. A ring-shaped beam deflector such as the deflector 802 can have a stepped or continuously varying wedge angle, can have a flat section without a wedge, or can have different wedges defined by a front surface and a rear surface. FIG. 8C is a sectional view of a representative implementation of the beam deflector 802. As shown in FIG. 8C, a wedge angle α is a function of an angular coordinate θ.

In an alternative configuration to that shown in FIG. 8A, it is possible to produce a beam scan using a plane-parallel plate and tilting the plate about an axis that is perpendicular to the axis 806. In such a configuration the plane-parallel plate effectively shifts the source relative to the lens 814 and produces a shift of the focus spot on the target. A plane-parallel plate can be tilted about two axes orthogonal to the axis 806 to produce a scan in two dimensions. Alternatively, the plate can be tilted on one axis that is perpendicular to the axis 806 and then rotated about the axis 806. This alternative approach can be convenient for producing circular or spiral scans, for example. A desirable aspect of this approach is that it is easy to nullify the scanning motion by positioning the plate perpendicular to the beam, in contrast to having to use two prisms to produce no net beam deviation (see FIG. 4A).

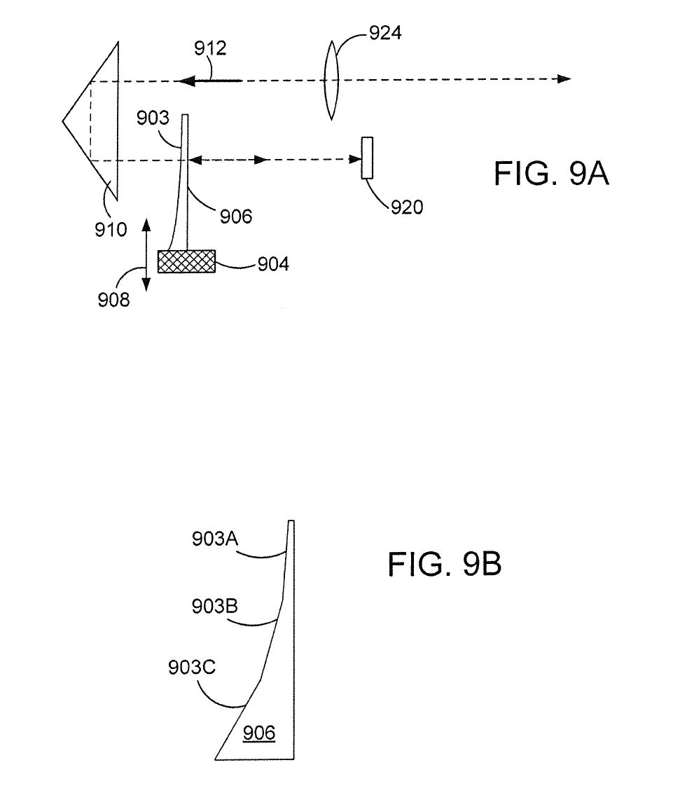

FIG. 9A illustrates a portion of a laser tracker or laser radar system that includes a variable wedge beam deflector 906 that is coupled to a linear actuator 904. The linear actuator translates the beam deflector along an axis 908. An input beam 912 is directed by a corner cube 910 or other reflector to the beam deflector 906 and to a return reflector 920. The beam deflector 906 has a variable thickness along 908 as defined by a surface 903, and translation of the beam deflector 906 scans the beam, formed by a lens 924, across a target. FIG. 9B is a representative sectional view of the beam deflector 906. The beam deflector 906 has wedge regions 903A-903C corresponding to different respective wedge angles. Fewer or more stepped regions can be used, or the wedge angle can vary continuously.

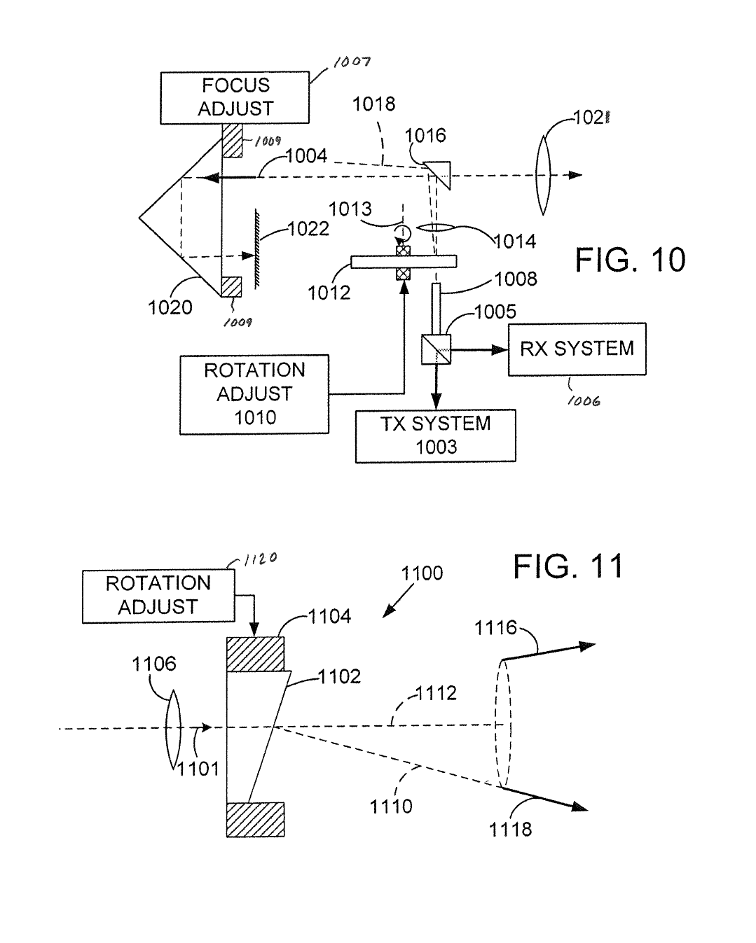

FIG. 10 illustrates a portion of an embodiment of a laser tracking or laser radar system that comprises a transmitter (“TX system”) 1003 that directs an optical flux through a beam splitter 1005 to an optical fiber section 1008. A beam-deflection system includes a rotation controller (“rotation adjust”) 1010 coupled to a beam deflector 1012 that is rotatable about an axis 1013. The beam deflector 1012 is configured to receive the optical flux from the optical fiber section 1008 and to transmit the flux to a lens 1014. Absent a variable deflection imposed by the beam deflector 1012, the flux is focused by the lens 1014 at or near a reflective surface 1016 and propagates along an axis 1004 to a corner cube 1020 and a return reflector 1022. The flux is then directed back to the corner cube 1020 to an objective lens 1021 that focuses the flux on a target. Deviations or deflections of the flux (e.g., 1018) by the beam deflector 1012 cause corresponding scanning of the beam produced by the lens 1021. The corner cube 1020 is coupled to a movable stage 1009 under the control of a focus adjust controller 1007. Also shown is the receiver (“RX system”) 1003.

In an alternative configuration to that shown in FIG. 10, it is possible to produce a beam scan using a plane-parallel plate and tilting the plate about an axis that is perpendicular to the axis 1013. In such a configuration the plane-parallel plate effectively shifts the source relative to the lens 1022 and produces a shift of the focus spot on the target. A plane-parallel plate can be tilted about two axes orthogonal to the axis 1013 to produce a scan in two dimensions. Alternatively, the plate can be tilted on one axis that is perpendicular to the axis 1013 and then rotated about the axis 1013. This alternative approach can be convenient for producing circular or spiral scans, for example. A desirable aspect of this approach is that it is easy to nullify the scanning motion by positioning the plate perpendicular to the beam, in contrast to having to use two prisms to produce no net beam deviation (see FIG. 4A).

FIG. 11 illustrates an embodiment of a beam scanner 1100 that comprises a prism 1102 situated on or in a rotational stage 1104 and configured to receive an optical beam 1101 from a lens 1106. The optical beam 1101 is refracted by the prism 1102 so as to propagate along an axis 1110 that is tilted with respect to a nominal propagation (non-deflected) axis 1112, and to produce scanned beams such as beams 1116, 1118. A rotation controller (“rotation adjust”) 1120 provides selected beam deflections based on the orientation of the prism 1102.

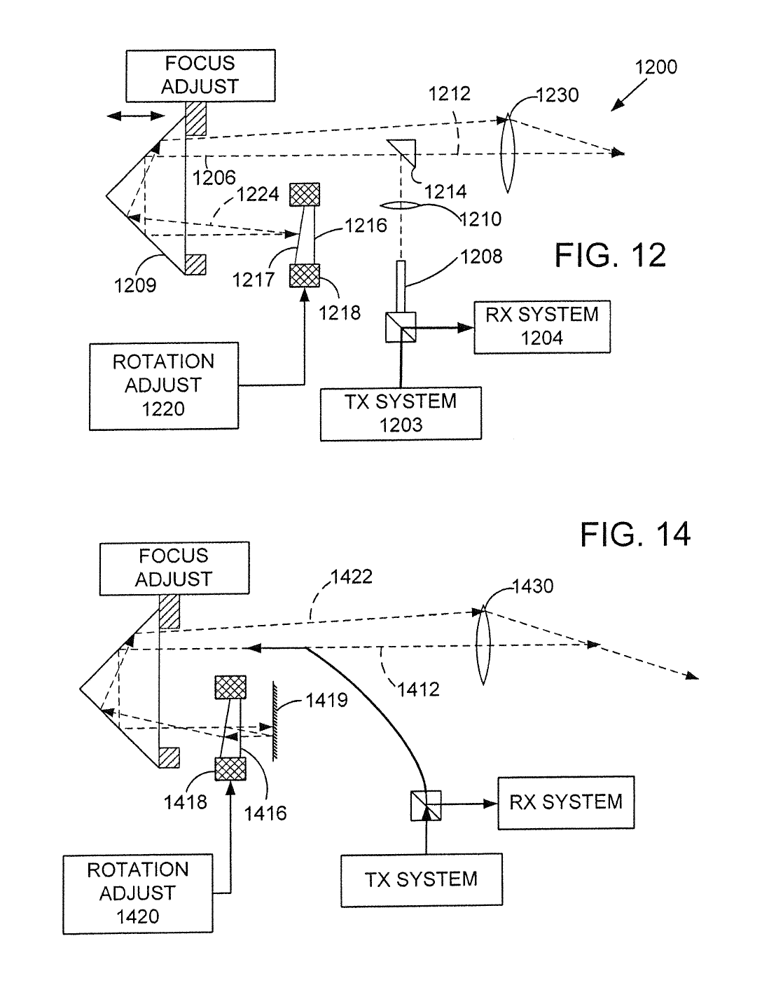

FIG. 12 illustrates an embodiment of a beam tracking or laser radar system 1200 that comprises a transmitter 1203 that couples a laser beam to a fiber 1208. The beam from the fiber 1208 is directed along an axis 1206 by a lens 1210 and a reflector 1214. The beam is reflected by a corner cube 1209 to a tiltable mirror 1216 coupled to a stage 1218. A rotation controller (“rotation adjust”) 1220 adjusts the tilt angle of the prism 1216, thereby producing a selected change in the axis 1206 to a deflection axis 1224. The resulting deflected beam can be scanned by making appropriate changes in the deflection angle by tilting the mirror 1216. The mirror 1216 can be both tilted and tipped to produce beam scanning in two axes. A beam, produced by the transmitting (“TX”) system 1203, passes through a lens 1210 and reflects from a beam splitter 1214 to the corner cube 1209. The corner cube is movable under control by a focus adjust. Also shown is a receiving (“RX”) system 1204.

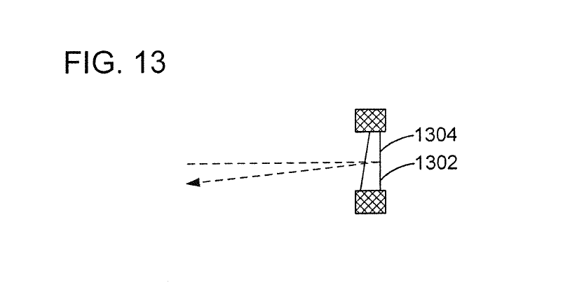

FIG. 13 illustrates an embodiment of a beam deflector that is similar to the embodiment of FIG. 12. However, in FIG. 13, a tiltable prism 1302 is used to reflect the incident beam from a rear surface 1304 thereof, not from a front surface 1217 of a mirror as shown in FIG. 12.

With reference to FIG. 14, an embodiment is shown in which the reflective prism 1216 of the embodiment of FIG. 12 is replaced with another prism 1416 and a reflector 1419. The prism 1416 is secured to a rotational stage 1418 controlled by a rotational controller (“rotation adjust”) 1420. An optical flux that is incident to the prism 1416 along the axis 1412 is deflected or scanned to as to propagate along an axis 1422. A lens 1430 receives the deflected beam and directs it to a target. Beam-scan angles are selected based on the tilt angle of the prism 1416. Also shown are a transmitting (“TX”) system and a receiving (“RX”) system.

For convenience, the examples described above generally include transparent or reflective prisms with plane surfaces, continuously curved surfaces, or stepped surfaces. Other beam deflectors that can be used include Fresnel lenses, diffraction gratings, holographic optical elements, or other diffractive, refractive, reflective, continuously varying, or stepped optical elements.

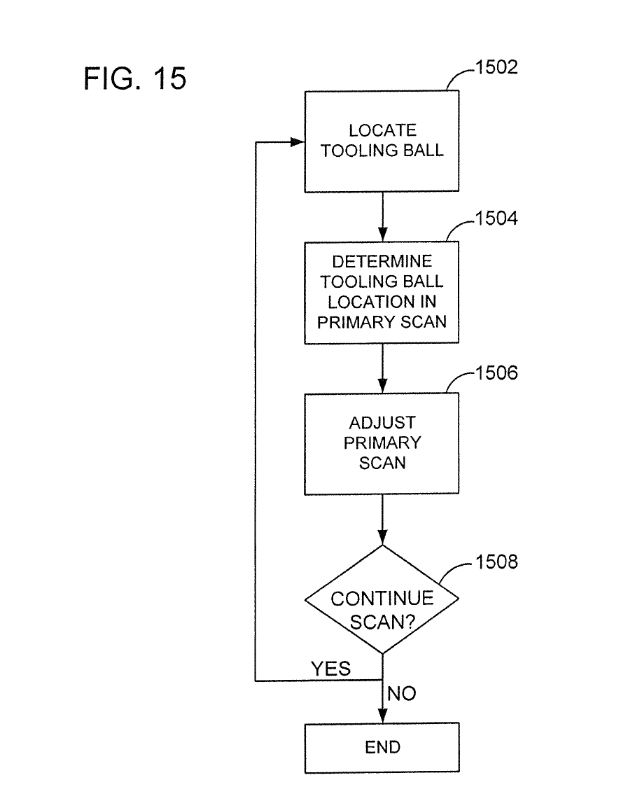

FIG. 15 illustrates a representative method for tracking a tooling ball secured to a substrate or target. One or more tooling balls can be secured to a target to provide reference points for coordinate determinations. A tooling ball generally includes a reflective ball-shaped surface that provides ample reflection of an interrogation beam in a laser-based measurement apparatus such as a laser radar. As shown in FIG. 15, at 1502 a tooling ball location is identified and recorded based on returned portions of a scanned interrogation optical beam. The optical beam can be scanned in a variety of patterns such as circles, spirals, w's, or zig-zags so as to track a tooling ball. At 1504, the identified location is evaluated to determine a tooling ball position with respect to a primary scan. The primary scan is adjusted at 1506 so that the tooling ball is located at a preferred location relative to the primary scan. Typically, the primary scan is adjusted so that the tooling ball location is approximately centered within a primary scan range. At 1508, a determination is made of whether to produce additional scanning. A secondary scanner can be used to track a tooling ball, and the primary scanner can be adjusted based on the secondary scanner so that the tooling ball remains centered or located at a preferred location in the optical beam scan.

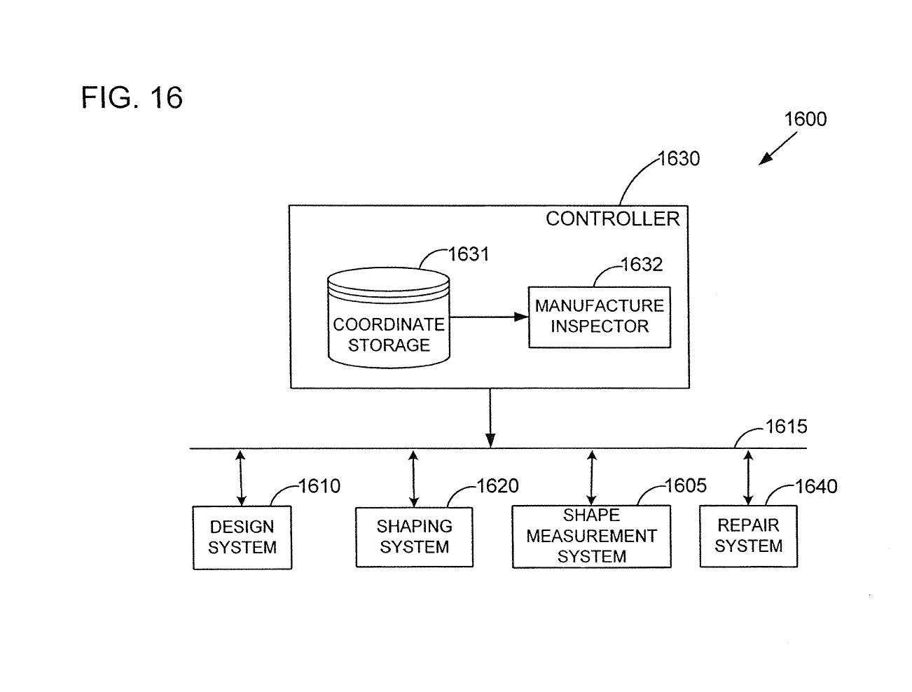

FIG. 16 illustrates an embodiment of a manufacturing system 1600 suitable for producing one or more components of a ship, airplane, or parts of other systems or apparatus, and for evaluating and reprocessing such manufactured components. The system 1600 typically includes a shape- or profile-measurement system 1605 such as the laser radar 100 discussed above. The manufacturing system 1600 also includes a design system 1610, a shaping system 1620, a controller 1630, and a repair system 1640. The controller 1630 includes coordinate storage 1631 configured to store measured and design coordinates or other characteristics of one or more manufactured structures as designed and/or measured. The coordinate storage 1631 is generally a computer-readable medium such as a hard disk, a random access memory, or other memory device. Typically, the design system 1610, the shaping system 1620, the shape-measurement system 1605, and the repair system 1640 communicate with each other via a communication bus 1615 using a network protocol.

The system 1610 is configured to create design information corresponding to shape, coordinates, dimensions, or other features of a structure to be manufactured, and to communicate the created design information to the shaping system 1620. The system 1610 can also communicate design information to the coordinate storage 1631 of the controller 1630 for storage. Design information typically includes information indicating the coordinates of some or all features of a structure to be produced.

The shaping system 1620 is configured to produce a structure based on the design information provided by the design system 1610. The shaping processes provided by the shaping system 1620 can include casting, forging, cutting, or other process. The shape-measurement system 1605 is configured to measure the coordinates of one or more features of the manufactured structure and to communicate, to the controller 1630, information indicating measured coordinates or other information related to structure shape.

A manufacture inspector 1632 of the controller 1630 is configured to obtain design information from the coordinate storage 1631, and to compare information such as coordinates or other shape information received from a profile-measuring apparatus such as the apparatus 100 of FIG. 1 with design information read out from the coordinate storage 1631. The manufacture inspector 1632 is generally provided as a processor and a series of computer-executable instructions that are stored in a tangible computer-readable medium such as a random access memory, a flash drive, a hard disk, or other memory device. Based on the comparison of design and actual structure data, the manufacture inspector 1632 can determine whether or not the manufacture structure is shaped in accordance with the design information, generally based on one or more design tolerances that can also be stored in the coordinate storage 1631. In other words, the manufacture inspector 1632 can determine whether or not the manufactured structure is defective or non-defective. When the structure is not shaped in accordance with the design information (and is defective), then the manufacture inspector 1632 determines whether or not the structure is repairable. If the structure is repairable, then the manufacture inspector 1632 can identify defective portions of the manufactured structure and provide suitable coordinates or other repair data. The manufacture inspector 1632 is configured to produce one or more repair instructions or repair data and to forward repair instructions and repair data to the repair system 1640. Such repair data can include locations requiring repair, the extent of re-shaping required, or other repair data. The repair system 1640 is configured to process defective portions of the manufactured structure based on the repair data.

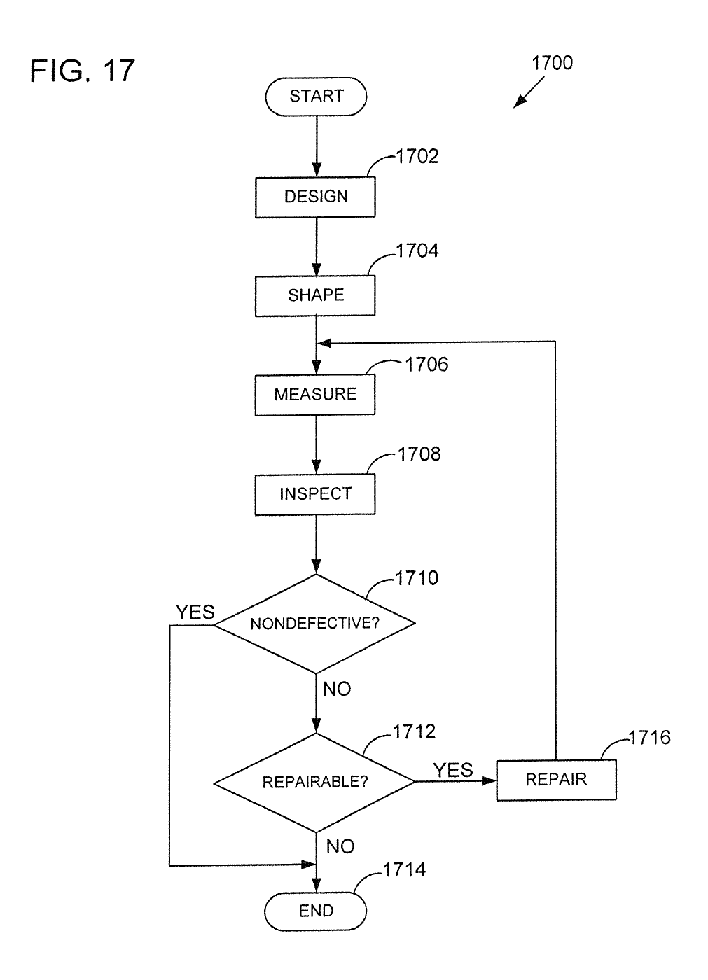

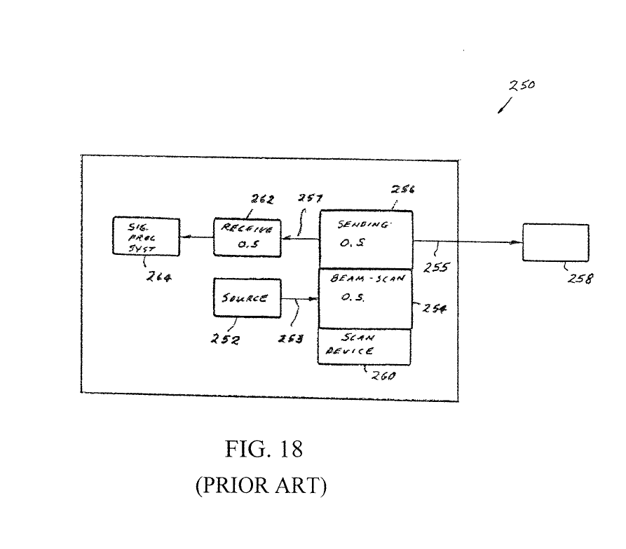

FIG. 17 is a flowchart of a representative embodiment of a manufacturing method 1700 that can incorporate manufacturing systems such as illustrated in FIG. 16. At 1702, design information is obtained or created corresponding to the shape of a structure to be manufactured. At 1704, the structure is manufactured or “shaped” based on the design information. At 1706, coordinates, dimensions, or other features of the manufactured structure are measured using a profile-measurement system, such as any of the laser radar systems described above, to obtain shape information corresponding to the structure as manufactured. Typically, profile measurement is accomplished with a fine scan and a coarse scan of a laser beam. At 1708, the manufactured structure is inspected based on a comparison of actual and design dimensions, coordinates, manufacturing tolerances, or other structure parameters. At 1710, if the manufactured structure is determined to be non-defective, the manufactured part is accepted and processing ends at 1714. If the manufactured part is determined to be defective at 1710 by, for example, the manufacture inspector 1632 of the controller 1630 as shown in FIG. 16, then at 1712 a determination is made of whether the manufactured part is repairable. If repairable, the manufactured part is reprocessed or repaired at 1716, and then measured, inspected, and reevaluated at 1706, 1708, 1710, respectively. If the manufactured part is determined to be unrepairable at 1712, the process ends at 1714.

According to the embodiment of FIG. 17, a manufactured structure can be evaluated using a profile-measurement system to measure or assess coordinates or other features of a manufactured structure. Thus, the structure can be evaluated to determine whether the structure is defective or not. If the structure is determined to be defective but repairable or reprocessable, a reprocessing process can be performed. By repeating measurement, inspection, and evaluation, defective parts can be readily identified and reprocessed, while structures that are defective and non-repairable can be set aside or discarded. The particular systems and methods of FIGS. 16-17 are exemplary only, and other arrangements alternatively can be used.

In the embodiment of FIG. 17, the manufacturing system 1700 can include a profile-measurement system comprising a laser radar 100, a design system 910, a shaping system 920, a controller 930 configured to determine whether a structure is acceptable (inspection apparatus), and a repair system 940. However, other systems and methods can be used, and the exemplary embodiments of FIGS. 16 and 17 are provided for convenient illustration and should not be regarded as limiting the scope of the this disclosure. We claim all that is encompassed by the appended claims.

Whereas the invention has been described in the context of multiple representative embodiments, it will be understood that it is not limited to those embodiments. On the contrary, it is intended to cover all modifications, alternatives, and equivalents as may be including within the spirit and scope of the invention, as defined by the appended claims.

We claim:

1. An optical system, comprising:
a beam-forming unit comprising a first optical element;
a beam-scan unit comprising a second optical element; and
a controller coupled to the beam-forming unit and beam-scan unit;
wherein the first optical element is movable to shape and direct an optical beam out along a nominal propagation axis, and the second optical element comprises at least one movable beam deflector that moves the optical beam in a scanning manner relative to the nominal propagation axis; and
the controller is configured to induce movement of the first optical element as required for shaping and directing the optical beam along the nominal propagation axis and to induce motion of the beam deflector of the second optical element as required to scan the optical beam relative to the nominal propagation axis.

2. The system of claim 1, wherein:
the second optical element comprises a rotatable or tiltable actuator coupled to the controller and to which the second optical element is coupled; and
the controller is configured to actuate the actuator as required to produce scanning motion of the optical beam.

3. The system of claim 1, further comprising a transmit/receive system coupled to the controller and configured to send the optical beam to the target and to receive at least a portion of the optical beam as reflected from the target.

4. The system of claim 3, wherein:
the transmit/receive system further comprises a source of the optical beam; and
the source comprises a laser that produces the optical beam.

5. The system of claim 1, wherein the second optical element is movable independently of movement of the first optical element.

6. The system of claim 1, wherein the first optical element is adjustable to vary at least one of focus of the optical beam as incident on the target, width of the optical beam as incident on the target, shape of the optical beam as incident on the target, and direction of the nominal propagation axis relative to the beam-shaping optical system.

7. The system of claim 1, wherein the first optical element is a reflective optical element.

8. The system of claim 7, wherein:
the reflective optical element is a corner cube situated to receive the optical beam from a light source; and
the second optical element is situated to receive the optical beam from the corner cube and configured to return the optical beam to the corner cube as the second optical element is being moved relative to the corner cube.

9. The system of claim 1, wherein:
the beam-forming unit further comprises a focus-adjust device;
the beam-scan unit further comprises a rotation-adjust device;
the focus-adjust device is coupled to the first optical element and to the controller to move the first optical element as required to focus the optical beam on the target; and
the rotation-adjust device is coupled to the second optical element and to the controller to adjust at least one parameter associated with movement of the beam deflector.

10. The system of claim 9, wherein:
the beam-forming unit further comprises a reflective optical element; and
the focus-adjust device adjusts a linear position of the reflective optical element as required to focus the optical beam on the target.

11. An optical system, comprising:
a beam-shaping optical system producing an optical beam;
a movable beam deflector directing the optical beam to a target; and
a beam-scan controller operably coupled to the beam deflector to produce an optical-beam scan angle, relative to a nominal propagation axis, based on an orientation of at least a portion of the beam-shaping optical system and a setting of the movable beam deflector.

12. The system of claim 11, wherein the optical beam is received from the beam-shaping optical system.

13. The system of claim 11, configured as a laser radar system, wherein the optical beam is an interrogation beam.

14. The system of claim 11, wherein the beam-scan controller is configured to establish a plurality of repeating scan angles.

15. The system of claim 11, wherein:
the beam-scan controller is configured to direct the optical beam in a pointing direction based on an orientation of at least a portion of the beam-shaping optical system; and
a movement axis of the beam deflector is parallel to the optical-beam pointing direction.

16. The system of claim 11, wherein the beam deflector comprises at least one rotatable optical element.

17. The system of claim 16, wherein the optical element comprises a mirror.

18. The system of claim 16, wherein the optical element comprises a wedge prism.

19. The system of claim 18, wherein the wedge prism is situated so that the optical beam produced by the beam-shaping optical system is incident at an angle to the wedge prism corresponding to a minimum deviation by the wedge prism.

20. The system of claim 16, wherein:
the beam deflector comprises a rotation stage; and
the optical element is coupled to the rotation stage.

21. The system of claim 16, wherein the beam deflector comprises a first rotatable wedge prism having a first wedge angle and a second rotatable wedge prism having a second wedge angle.

22. The system of claim 21, further comprising first and second rotation stages coupled to the first and second rotatable wedge prisms, respectively.

23. The system of claim 11, further comprising an optical detection system configured to receive at least a portion of interrogation optical beam from the target and to produce a target assessment based on the received portion.

24. The system of claim 23, wherein the target assessment is associated with a target distance or a target shape.

25. The system of claim 24, wherein:
the beam scan controller is configured to establish an interrogation optical beam pointing direction based on an orientation of at least a portion of the beam-shaping optical system and rotate the scan angle about the pointing direction so as to define a scan path; and
the target assessment produced by the optical detection system is at least one of a target dimension or a target surface profile.

26. The system of claim 25, wherein the target assessment is based on at least a magnitude of the received portion and the scan angle.

27. The system of claim 11, further comprising an optical detection system configured to receive at least a portions of the interrogation optical beam from the target and to produce a target assessment based on the received portions and the associated scan angles.

28. The system of claim 27, wherein:
the beam scan controller is configured to establish an interrogation optical beam pointing direction based on an orientation of at least a portion of the beam shaping optical system and to rotate the scan angle about the orientation so as to define a scan path; and
the target assessment produced by the optical detection system is at least one of a target feature dimension or target feature location.

29. The optical system of claim 11, configured as a laser radar system.

30. The optical system of claim 1, configured as a laser radar system.

31. A method, comprising:
establishing a beam orientation of an optical beam along a nominal propagation axis using a beam-shaping optical system;
scanning the optical beam about the nominal propagation axis using a movable beam deflector;
delivering the scanned beam to a target;
receiving at least a portion of the beam back from the target; and
determining a characteristic of the target based on the received portion.

32. The method of claim 31, wherein the beam is scanned along a circular path relative to the nominal propagation axis.

33. The method of claim 31, further comprising:
adjusting the optical beam orientation based on the determined target characteristic; and
re-determining the target characteristic.

34. The method of claim 31, wherein:
the optical beam orientation is established with respect to a selected target feature; and
using the beam deflector, the optical beam is scanned about the selected target feature.

35. The method of claim 31, wherein the beam deflector comprises at least one refractive optical element.

36. The method of claim 35, wherein:
the refractive optical element comprises a wedge prism; and
scanning of the optical beam is produced by deviating the optical beam by transmission through the wedge prism as the wedge prism moves.

37. The method of claim 36, wherein the wedge prism is situated at an angle associated with a minimum optical beam deviation.

38. The method of claim 31, wherein:
the beam deflector comprises a reflective optical element; and
scanning of the optical beam is produced by deviating the optical beam by reflection from the reflective optical element as the reflective optical element moves.

39. An optical apparatus, comprising:
a beam-forming optical system configured to produce an optical beam;
a primary beam scanner situated and configured to produce a primary scan of the optical beam, using the beam-forming optical system;
a secondary beam scanner situated and configured to receive the optical beam from the primary beam scanner and produce a secondary scan, such that the scanning optical beam is directed along a scan path defined by the primary and secondary beam scanners; and
an optical detection system configured to estimate target distances associated with at least a portion of the scan path based on portions of the optical beam received from the target.

40. The apparatus of claim 39, further comprising a scan controller configured to establish the primary scan based on an at least one target distance produced by the optical detection system.

41. The apparatus of claim 39, wherein the secondary beam scanner includes at least one refractive optical element situated to receive the optical beam from the primary beam scanner and transmit the received optical beam along the scan path.

42. The apparatus of claim 41, wherein:
the at least one refractive optical element includes at least a first wedge prism and a second wedge prism;
the first wedge prism is situated and configured to receive the optical beam from the primary beam scanner and to transmit the received optical beam to the second wedge prism; and
the second wedge prism is situated and configured to transmit the optical beam from the first wedge prism along the scan path.

43. The apparatus of claim 39, wherein the secondary beam scanner includes at least one reflective optical element situated to receive the optical beam from the primary beam scanner and reflect the received optical beam along the scan path.

44. A laser radar apparatus, comprising:
an optical fiber situated to emit an optical beam along an axis;
a corner cube situated along the axis so as to receive the emitted optical beam;
a displacement stage coupled to the corner cube and configured to displace the corner cube along the axis;
a return reflector situated along the axis to receive the emitted optical beam from the corner cube and reflect the emitted optical beam as a returned beam to the corner cube;
a beam-forming lens situated along the axis to receive the returned beam from the corner cube and produce an interrogation beam;
a focus controller coupled to the displacement stage and configured to adjust a separation of the corner cube and the beam forming lens so as to focus the interrogation beam at a selected target distance;
a primary beam scanner configured to direct the axis toward a selected target location; and
a secondary beam scanner coupled to produce scan-inducing movement of an optical element so as to produce an angular deviation of the interrogation beam with respect to the axis so as to define a scan path.

45. The laser radar of claim 44, further comprising:
an optical receiver system configured detect at least portions of the interrogation optical beam returned from a target; and
a processor coupled to the optical receiver systems and configured to determine a target characteristic for at least a portion of the target based on the detected portions of the interrogation optical signal and the scan path.

46. The laser radar of claim 44, wherein the optical element of the secondary beam scanner comprises at least one refractive optical element, wherein the secondary beam scanner is coupled to produce a scan-inducing motion of the refractive optical element.

47. The laser radar of claim 46, wherein the refractive optical element comprises a wedge prism.

48. The laser radar of claim 44, wherein the optical element of the secondary beam scanner comprises at least one reflective optical element, wherein the secondary beam scanner is coupled to produce a scan-inducing motion of the reflective optical element.

49. The laser radar of claim 44, further comprising a rotatable reflective surface, wherein the secondary beam scanner is coupled to produce a rotation of the rotatable reflective surface.

50. A manufacturing system, comprising:
a design system including a data storage device;
a profile-shaping system coupled to the design system and configured to form a profile on a workpiece according to design data provided by the design system;
a profile-measurement system configured to measure the profile formed by the profile-shaping system, the profile-measurement system comprising a laser radar as recited in claim 44; and
an inspection system coupled to the profile-measurement system and to the data storage device, and configured to compare profile data from the profile-measurement system with design data from the design system.

51. The manufacturing system of claim 50, further comprising a repair system configured to, whenever the inspection system detects a significant error in the profile data from the profile-measurement system relative to the design data, perform a repair on a corresponding region of the workpiece.

52. A manufacturing system, comprising:
a design system including a data storage device;
a profile-shaping system coupled to the design system and configured to form a profile on a workpiece according to design data provided by the design system;
a profile-measurement system configured to measure the profile formed by the profile-shaping system, the profile-measurement system comprising an optical apparatus as recited in claim 44; and
an inspection system coupled to the profile-measurement system and to the data storage device, and configured to compare profile data from the profile-measurement system with design data from the design system.
